(19) United States
(12) Patent Application Publication
(10) Pub. No.: US 2010/0054765 A1
(43) Pub. Date: Mar. 4, 2010

(54) DEVELOPING DEVICE

(75) Inventors: Hiroshi Murata, Yokohama-shi (JP); Takao Izumi, Yokohama-shi (JP); Norikazu Ochiai, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/547,979

(22) Filed: Aug. 26, 2009

Related U.S. Application Data
(60) Provisional application No. 61/093,577, filed on Sep. 2, 2008.

(51) Int. Cl. G03G 15/08

(52) U.S. Cl. 399/27; 399/260; 399/254; 399/258

(57) ABSTRACT

A developing device includes a developer tank that contains a developer including a toner and a carrier, a developing agent supplier that develops a latent image by using the toner contained in the developer tank, a discharge port that is provided in a side surface of the developer tank and discharges the developer, and a discharge assisting member that protrudes from a downstream side of the discharge port in a direction of flow of the developer in the developer tank and in a direction crossing the direction of the flow of the developer.

### CROSS-REFERENCE TO RELATED APPLICATION

This application claims the benefit of U.S. Provisional Application No. 61/093,577, filed Sep. 2, 2008.

### TECHNICAL FIELD

The present invention relates to a developing device of an image forming apparatus.

### BACKGROUND

In an apparatus using an electrophotographic technique, such as a copier, a printer or a facsimile, a two-component developer including a toner and a carrier, for developing an electrostatic latent image on a surface of a photoconductive body, is contained in a developing device. The developing device supplies the toner to the surface of the photoconductive body.

In a dry two-component developer, although the toner is consumed by the development, the carrier remains in the developing device. A resin coat material of the surface of the carrier is peeled off or a toner component is attached to the surface. The carrier as stated above deteriorates in charging performance as the developer, and causes the degradation of image characteristics.

In view of the above, a method of replenishing the developing device with the carrier in addition to the toner is proposed. Differently from a method in which all the developers are replaced at a time in the life, in this system, the carrier is also replenished at the same time as the toner during a normal developing operation. Although the toner is consumed by the development, the supplied carrier remains in the developing device. When toner density of the developing device is kept constant, the bulk of the developer in the developing device is increased. The developer overflowing from the developing device is discharged to the outside of the developing device. This is a discharging method using the so-called overflow.

In addition to this, some methods for discharging the developer from the developing device are proposed. There is a method in which the toner and carrier are separately supplied to the developing device. Further, there is a method in which a developer obtained by mixing a small amount of carrier to a toner cartridge containing a toner is supplied to the developing device. Further, JP-A-62-127874 and JP-A-6-301289 disclose a method in which a degraded developer is partially discharged by control from the developing device at a specified timing, and a developer is newly supplied. In this way, the developer keeps the performance. Further, the performance of the developer is kept, so that the number of times of replacement of the developer is reduced and the maintenance property is improved.

However, the characteristics of the developer such as its physical property, fluidity and bulk density are changed due to the environment and the life (time degradation of the developer). In the developing device, even if the supply and discharge of the developer is performed by one of the above methods, the amount of the developer excessively increases more than a reference amount due to the characteristic change of the developer.

Further, when an image forming apparatus continuously outputs a large number of sheets of images each having a high print ratio, since the supply amount of the developer becomes large in the developing device, the developer amount increases more than the reference amount. When the developer amount of the developing device excessively increases more than the reference amount, the following problems arise. A blurred image appears on a printed sheet due to the defective peeling of the developer in a developing roller portion. Since the rotation torque of the developing device is raised, the developing device is locked, and the operation is stopped. The fluidity of the developer is lowered, and the developer is hard to be discharged from the developing device. Thus, the developer amount of the developing device further increases more than the reference amount. When the developer amount of the developing device further increases more than the reference amount, the developer is compressed in the developing device and is further hard to be discharged from the discharge port to the outside. As a result, the developer amount of the developing device is further increased.

JP-A-2004-151634 and JP-A-08-123180 disclose members to assist the discharge when the developer is discharged from the developing device. However, these members do not solve the above problem.

Accordingly, the present invention provides a developing device having a structure in which a developer can be efficiently discharged to the outside.

### SUMMARY

According to one aspect of the present invention, there is provided a developing device comprising: a developer tank that contains a developer including a toner and a carrier, a developing roller that develops a latent image by using the toner contained in the developer tank, a discharge port that is provided in a side surface of the developer tank and discharges the developer, and a discharge assisting member that protrudes from a downstream side of the discharge port in a direction of flow of the developer in the developer tank and in a direction crossing the direction of the flow of the developer.

### DESCRIPTION OF THE DRAWINGS

FIG. 1 is a perspective view showing an outer appearance of an image forming apparatus.

FIG. 2 is a schematic view seen from front side, showing an inner structure of the image forming apparatus.

FIG. 3 is a perspective view of a developing device.

FIG. 4 is a top sectional view of the developing device in a longitudinal direction.

FIG. 5 is a side sectional view of the developing device in the longitudinal direction.

FIG. 6 is a plan view of the developing device.

FIG. 7 is an enlarged top sectional view of the developing device showing a broken line portion of FIG. 4.

FIG. 8 is an enlarged side sectional view of the developing device showing a broken line portion of FIG. 5.

FIG. 9 is a graph showing a relation between the number of sheets of image output of the image forming apparatus and developer weight.

FIG. 10 is an enlarged top sectional view of the developing device showing a broken line portion of FIG. 7.

FIG. 11 is a graph showing a relation between the number of sheets of image output of the image forming apparatus and developer weight when the arrangement of a discharge assisting member is changed.

FIG. 12 is a side sectional view of a developing device in which the position of a discharge assisting member is changed as a comparative example.

FIG. 13 is a graph showing a relation between the number of sheets of image output of the image forming apparatus and developer weight.

### DETAILED DESCRIPTION

Hereinafter, embodiments will be described with reference to the drawings.

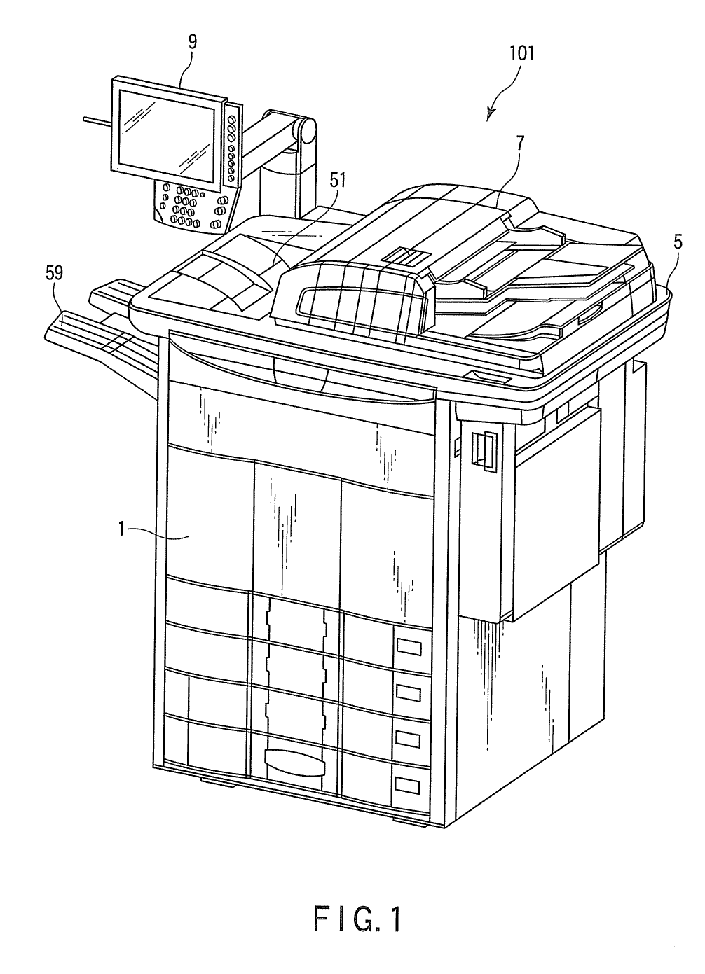

FIG. 1 is a perspective view showing an outer appearance of an image forming apparatus 101 of an embodiment. The image forming apparatus 101 is, for example, a four-tandem color copier. The image forming apparatus 101 includes an image forming unit 1, a sheet supply unit 3 and a scanner (image reading unit) 5. The image forming unit 1 outputs image information as an output image called, for example, a hard copy or a printout. The sheet supply unit 3 supplies a sheet of an arbitrary size used for image output to the image forming unit 1. The image reading unit 5 captures, as image data, the image information, which is an object of image formation in the image forming unit 1, from an original document holding the image information.

Incidentally, an auto document feeder 7 is provided above the image forming unit 1. The auto document feeder discharges, when an original document is sheet-like, the original document from a read position to a discharge position after reading of the image information by the image reading unit 5 is ended, and guides a next original document to the read position. An instruction input unit to instruct start of image formation in the image forming unit 1 and start for reading the image information of an original document by the image reading unit 5, that is, a display unit 9 as a control panel is provided in the image forming apparatus 101.

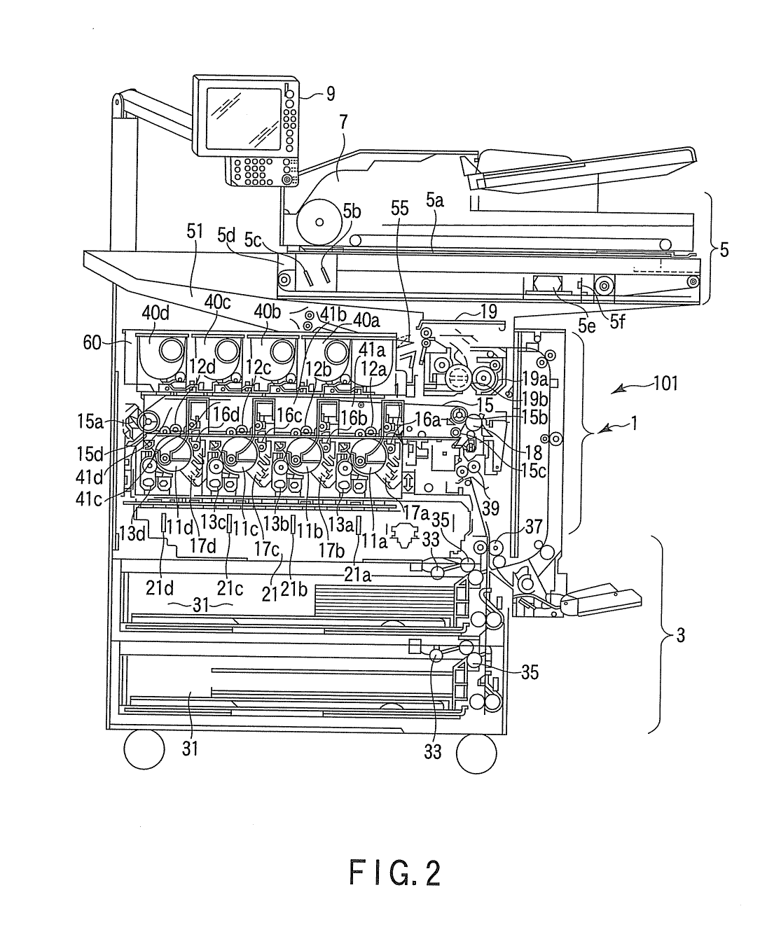

FIG. 2 is a schematic view seen from front side, showing an inner structure of the image forming apparatus 101. First, a structure of the image reading unit 5 will be described. The image reading unit 5 includes a transparent platen glass 5a on which an original document is placed, a light source 5b to irradiate the original document, and a reflecting mirror 5c to reflect light reflected from the original document. The light source 5b and the reflecting mirror 5c are provided integrally with a document illumination unit 5d movable in the horizontal direction. The reflected light of the document illumination unit 5d is received by a CCD 5f through an imaging lens 5e arranged on a light path.

Next, a structure of the image forming unit 1 will be described. Toner cartridges 40a to 40d are arranged side by side at an upper side of the image forming unit 1. The toner cartridge 40a contains a developer including a yellow toner. The toner cartridge 40b contains a developer including a magenta toner. The toner cartridge 40c contains a developer including a cyan toner. The toner cartridge 40d contains a developer including a black toner. Toner hoppers 41a to 41d are arranged side by side at a lower side of the toner cartridges 40a to 40d. The toner cartridge 40a supplies the developer to the toner hopper 41a. The toner hopper 41a supplies the developer to a developing device 13a. The same applies to the toner hoppers 41b to 41d.

The image forming unit 1 includes photoconductive drums 11a to 11d, developing devices 13a to 13d, an intermediate transfer belt 15, cleaners 16a to 16d, charging chargers 17a to 17d, and an exposure device 21. The photoconductive drums 11a to 11d are image carriers to hold electrostatic latent images. The developing devices 13a to 13d inversely develop the electrostatic latent images formed on the photoconductive drums 11a to 11d. The developing device 13a contains the developer including the yellow toner. The developing device 13b contains the developer including the magenta toner. The developing device 13c contains the developer including the cyan toner. The developing device 13d contains the developer including the black toner. The intermediate transfer belt 15 is a transfer target body to sequentially hold toner images developed on the photoconductive drums 11a to 11d in a laminated state. The cleaners 16a to 16d remove surface charges on the photoconductive drums 11a to 11d by uniform light irradiation, and remove and contain toners remaining on the photoconductive drums 11a to 11d from the respective photoconductive drums 11a to 11d. The charging charger 17a to 17d uniformly negatively charge the photoconductive drums 11a to 11d. The exposure device 21 include LDs 21a to 21d to irradiate the photoconductive drums 11a to 11d with laser lights modulated according to writing image data and to form electrostatic latent images. The exposure device 21 may include LEDs or the like.

The photoconductive drum 11a, the developing device 13a, the cleaner 16a, the charging charger 17a, and the LD 21a constitute a process unit 200a. The process unit 200a includes the arrangement in which the photoconductive drum 11a is centered. Around the photoconductive drum 11a and along the rotation direction thereof, the LD 21a is provided downstream of the charging charger 17a, and the developing device 13a is provided downstream of the LD 21a. The photoconductive drum 11a is provided to contact with the intermediate transfer belt 15. The cleaner 16a is provided downstream of a place (primary transfer section) where the intermediate transfer belt 15 contacts with the photoconductive drum 11a.

The charging charger 17a charges the photoconductive drum 11a and the process unit 200a starts one cycle of transfer to the intermediate transfer belt 15. With the rotation of the photoconductive drum 11a, the cleaner 16a removes the toner, and the process unit 200a completes the one cycle of the transfer to the intermediate transfer belt 15. The charging charger 17a uniformly charges the uncharged photoconductive drum 11a, and the process unit 200a starts next one cycle of transfer to the intermediate transfer belt 15.

In the image forming unit 1, a process unit 200b, a process unit 200c and a process unit 200d are respectively provided to include the photoconductive drum 11b, the photoconductive drum 11c and the photoconductive drum 11d similarly to the process unit 200a. Accordingly, the image forming unit 1 includes the four process units.

The image forming unit 1 further includes a transfer device 18 and a fixing device 19. The transfer device 18 is a secondary transfer section to transfer the toner images laminated on the intermediate transfer belt 15 to a sheet. The fixing device 19 fixes the toner images, which were transferred to the sheet, to the sheet.

The intermediate transfer belt 15 is stretched by a drive roll 15a, backup roll 15b and a tension roll 15c. The drive roll 15a rotates the intermediate transfer belt 15. The backup roll 15b is a roller for secondary transfer. The tension roll 15c keeps the tension applied to the intermediate transfer belt 15 constant. At a place of the intermediate transfer belt 15 where the drive roll 15a is provided, a belt cleaner 15d is disposed to contact with the intermediate transfer belt 15 at the position where the belt cleaner faces the drive roll 15a through the intermediate transfer belt 15. The intermediate transfer belt 15 has a width almost equal to the sizes of the photoconductive drums 11a to 11d in a direction orthogonal to the conveyance direction. The intermediate transfer belt 15 has a seamless belt shape.

The intermediate transfer belt 15 is formed of polyimide resin having a thickness of 100 μm in which carbon is uniformly dispersed. The intermediate transfer belt 15 has an electric resistance of 10⁹ Ωcm. The intermediate transfer belt 15 is semiconductive. The intermediate transfer belt 15 may be formed of any material as long as the material is a semiconductive material having a volume resistance value of 10⁸ to 10¹¹ Ωcm. For example, the intermediate transfer belt 15 may be formed of a material in which conductive particles of carbon or the like are dispersed in polyethylene terephthalate, polycarbonate, polytetrafluoroethylene, polyvinylidene fluoride or the like. The intermediate transfer belt 15 may be formed of a polymeric film whose electric resistance is adjusted by composition adjustment. Further, the intermediate transfer belt 15 may be formed of a material in which an ion conductive material is mixed in a polymeric film, or a rubber material, such as silicone rubber or urethane rubber, having a relatively low electric resistance.

In the primary transfer section, primary transfer rolls 12a to 12d as transfer devices are respectively disposed at the back side of the intermediate transfer belt 15 to come in press contact with the photoconductive drums 11a to 11d through the intermediate transfer belt 15. That is, the primary transfer rolls 12a to 12d are respectively provided to face and contact with the process units 200a to 200d through the intermediate transfer belt 15. Further, the primary transfer roll 12a is connected to a not-shown positive DC power source. The primary transfer rolls 12b to 12d are similar to the primary transfer roll 12a.

The transfer device 18 is disposed to contact with the toner carrying surface side of the intermediate transfer belt 15. Further, the transfer device 18 faces the backup roll 15b disposed on the back side of the intermediate transfer belt 15. The backup roll 15b has an opposite electrode to the transfer device 18.

Next, a color image formation operation in the image forming apparatus 101 will be described. When an instruction of image formation start is inputted to the image forming apparatus 101, the photoconductive drum 11a receives a drive force from a not-shown drive mechanism and starts to rotate. The photoconductive drum 11a has a cylindrical shape having a diameter of 30 mm. The charging charger 17a uniformly charges the photoconductive drum 11a to about −600 V. The LD 21a irradiates the photoconductive drum 11a with light corresponding to an image to be recorded and forms an electrostatic latent image.

The developing device 13a gives a bias value of −380 V to a not-shown development sleeve by a not-shown development bias power source, and forms a development electric field between the development sleeve and the photoconductive drum 11a. The development electric field is directed from the surface of the photoconductive drum 11a to the development sleeve of the developing device 13a. The developing device 13a contains a developer (two-component developer in which a yellow toner and a ferrite carrier are mixed). The structure of the developing device 13a will be described later in detail. The negatively charged yellow toner is attached to an area of an image portion potential (high potential portion) of the electrostatic latent image on the photoconductive drum 11a.

Next, the developing device 13b develops an electrostatic latent image by a method different from the formation of the yellow toner image on the photoconductive drum 11a by the developing device 13a, and forms a magenta toner image on the photoconductive drum 11b. The magenta toner has a volume average particle diameter of 7 μm similarly to the yellow toner. The magenta toner is negatively charged by friction charging with a ferrite magnetic carrier particle having a volume average particle diameter of about 50 μm. The average charge amount of the magenta toner is about −30 μC/g. The developing device 13b gives a bias value of −380 V to a not-shown development sleeve by a not-shown development bias power source, and forms a development electric field between the development sleeve and the photoconductive drum 11b. The negatively charged magenta toner is attached to an area of a high potential portion of the electrostatic latent image on the photoconductive drum 11b.

In a transfer area Ta formed of the photoconductive drum 11a, the intermediate transfer belt 15 and the primary transfer roll 12a of the process unit 200a, a bias voltage of about +1000 V is applied from a DC power source to the primary transfer roll 12a. A transfer electric field is formed between the primary transfer roll 12a and the photoconductive drum 11a. The yellow toner image on the photoconductive drum 11a is transferred onto the intermediate transfer belt 15 in accordance with the transfer electric field.

The primary transfer roll 12a will be described in detail. The primary transfer roll 12a is a conductive foamed urethane roller which is made conductive by dispersing carbon. The primary transfer roll 12a is formed of a core metal of φ10 mm and a roller of an outer diameter of φ18 mm. The electric resistance between the core metal and the surface of the roller is about 10⁶Ω. The core metal is connected with a not-shown constant voltage DC power source. A feed device in the primary transfer roll 12a is not limited to a roller, but may be a conductive brush, a conductive rubber blade, a conductive sheet or the like. The conductive sheet is a carbon dispersed rubber material or a resin film. The conductive sheet may be a rubber material such as silicone rubber, urethane rubber or EPDM, or a resin material such as polycarbonate. It is desirable that the conductive sheet has a volume resistance value of 10⁵ to 10⁷ Ωcm.

A pair of springs are provided at both ends of the primary transfer roll 12a. The primary transfer roll 12a is urged by the pair of springs so as to contact with the intermediate transfer belt 15 elastically in the vertical direction. The magnitude of the urging force by the pair of springs provided on the primary transfer roll 12a is 600 gft. The urging force of one of the pair of springs is 300 gft. Since the structures of the primary transfer rolls 12b to 12d are the same as that of the primary transfer roll 12a and the structure of elastic contact with the intermediate transfer belt 15 is also the same, their description is omitted.

The intermediate transfer belt 15 on which the yellow toner image is transferred in the transfer area Ta is conveyed to a transfer area Tb. In the transfer area Tb of the process unit 200b, a bias voltage of about +1200 V is applied from the DC power source to the primary transfer roll 12b. The magenta toner image on the photoconductive drum 11b is superimposed on the yellow toner image and is transferred onto the intermediate transfer belt 15 in accordance with the transfer electric field. In a transfer area Tc of the process unit 200c, a bias voltage of about +1400 V is applied from the DC power source to the primary transfer roll 12c. The cyan toner image on the photoconductive drum 11c is superimposed on the yellow toner image and the magenta toner image, and is transferred onto the intermediate transfer belt 15 in accordance with the transfer electric field. In a transfer area Td of the process unit 200d, a bias voltage of about +1600 V is applied from the DC power source to the primary transfer roll 12d. The black toner image on the photoconductive drum 11d is superimposed on the yellow toner image, the magenta toner image and the cyan toner image, and is transferred onto the intermediate transfer belt 15 in accordance with the transfer electric field. As described above, the multiple transferred toner images are transferred onto the intermediate transfer belt 15.

The sheet supply unit 3 supplies a sheet at a specified timing to the transfer device 18 when the transfer device 18 transfers the toner images to the sheet. Cassettes set in plural cassette slots 31 contain sheets of arbitrary sizes. According to an image formation operation, the pickup roller 33 takes out a sheet. The size of the sheet corresponds to the size of the toner image formed by the image forming unit 1. A separation mechanism 35 prevents the pickup roller 33 from taking out two or more sheets from the cassette. Plural conveyance rollers 37 convey the sheet the number of which is restricted to one by the separation mechanism 35 to a register roller pair 39. The register roller pair 39 sends the sheet to a transfer position where the transfer device 18 contacts with the intermediate transfer belt 15 in synchronization with the timing when the transfer device 18 transfers the toner image from the intermediate transfer belt 15. Incidentally, the numbers of the cassette slots 31, the pickup rollers 33 and the separation mechanisms 35 are made two or more when necessary, and the cassette can be arbitrarily installed in any slot.

The backup roll 15b and the transfer device 18 transfer the toner images of the plural colors, which were transferred to the intermediate transfer belt 15, to the sheet such as, for example, a paper in the secondary transfer section. A specified bias is applied to the transfer device 18. The transfer device 18 forms a transfer electric field between itself and the backup roll 15b through the intermediate transfer belt 15. The transfer device 18 and the backup roll 15b transfer the multiple color toner images on the intermediate transfer belt 15 to the sheet collectively.

The sheet on which image information is fixed by the fixing device 19 is discharged to a storage tray 51 at a side of the image reading unit 5 and above the image forming unit 1. Here, the fixing device 19 includes a fixing roller 19a and a pressure roller 19d at the downstream side in the sheet conveyance direction. With respect to the sheet on which the toner image is transferred, the toner image is melted by the heated fixing roller 19a and the pressure roller, and the image information is fixed.

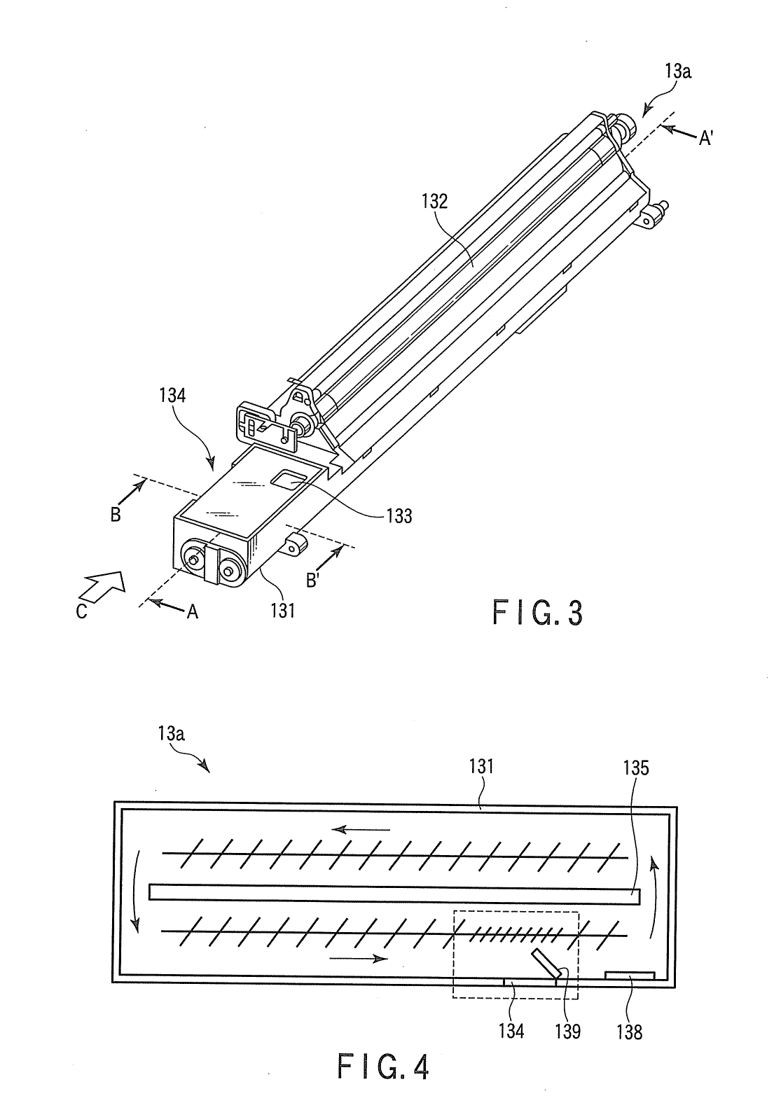

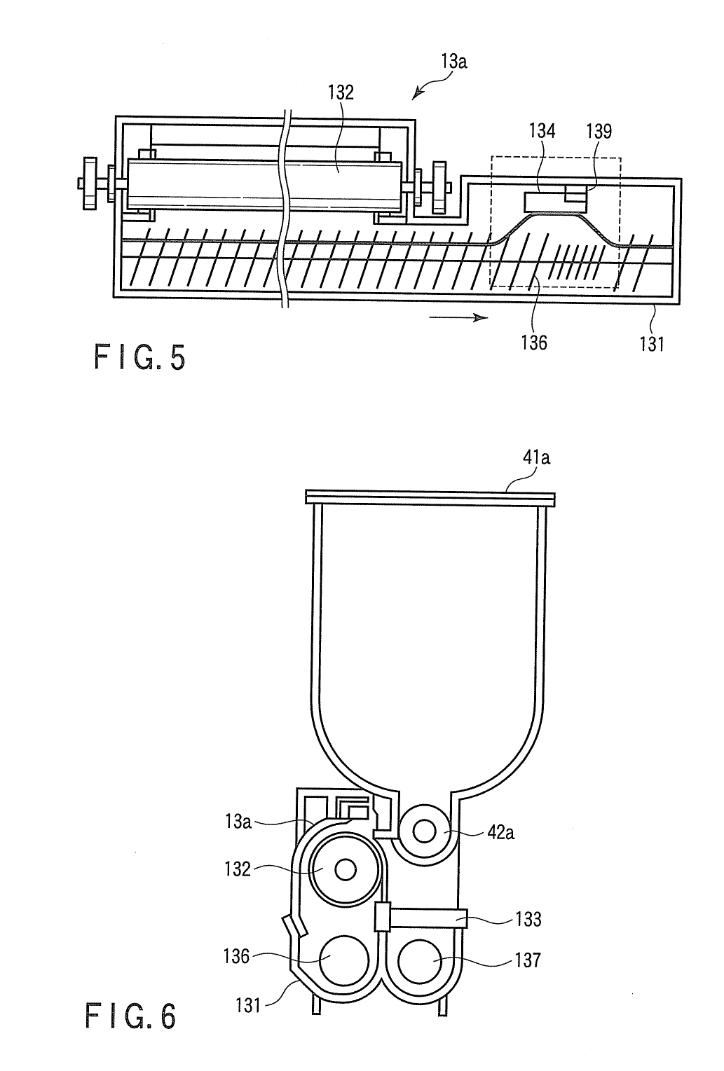

Next, the structure of the developing device 13a of the embodiment will be described. FIG. 3 is a perspective view of the developing device 13a. FIG. 4 is a top sectional view of A-A′ along the longitudinal direction of the developing device 13a of FIG. 3. FIG. 5 is a side sectional view of B-B′ along the longitudinal direction of the developing device 13a of FIG. 3. FIG. 6 is a view of the developing device 13a seen from an arrow C direction of FIG. 3. Hereinafter, although the developing device 13a will be described, the same applies to the developing devices 13b to 13d.

As shown in FIG. 3, the developing device 13a includes a developer tank 131, a developing roller 132, a replenishment port 133, and a discharge port 134. The developer tank 131 contains a developer. The developing roller 132 as a developing agent supplier is rotatably provided. The developing roller 132 is disposed to face the photoconductive drum 11a. The developing roller 132 rotates so that toner and carrier contained in the developer tank 131 is replenished. The replenishment port 133 is provided in the upper surface of the developer tank 131. The replenishment port 133 replenishes the yellow toner from the toner cartridge 40a to the developer tank 131. The discharge port 134 is provided in a side surface of the developer tank 131. The discharge port 134 discharges the developer contained in the developer tank 131 by overflow. The discharge port 134 is rectangular and has a long side in a direction parallel to the longitudinal direction of the developer tank 131 and a short side in a height direction orthogonal to the longitudinal direction of the developer tank 131. The discharge port 134 is provided with a discharge assisting member 139. The discharge assisting member 139 will be described later.

As shown in FIG. 4, the developer tank 131 includes a partition plate 135, a first mixer 136, a second mixer 137, and a toner density detection device 138. The developer tank 131 is divided into two spaces in the longitudinal direction by the partition plate 125. The two spaces communicate with each other at both ends of the developer tank 131 in the longitudinal direction. The first mixer 136 and the second mixer 137 are provided in the longitudinal direction of the developer tank 131. The first mixer 136 and the second mixer 137 rotate to agitate and convey the developer in the developer tank 131. The first mixer 136 conveys the developer in the opposite direction to the conveyance direction of the developer by the second mixer 137 in the longitudinal direction of the developer tank 131. Accordingly, the developer circulates in an arrow direction in the two spaces of the developer tank 131. The replenishment port 133 shown in FIG. 3 is provided at a position facing the second mixer 137 in the developer tank 131. That is, the developer is replenished into the space of the developer tank 131 where the second mixer 137 is provided. The developing roller 132 shown in FIG. 3 is provided at a position facing the first mixer 136 of the developer tank 131. The space of the developer tank 131 where the first mixer 136 is provided is a developer conveyance path at the side of the developing roller 132. The toner density detection device 138 is provided in the space of the developer tank 131 where the first mixer 136 is provided. The toner density detection device 138 detects the toner density of the developer conveyed by the first mixer 136.

As shown in FIG. 5, the developing roller 132 is provided from one end side to almost the center of the developer tank 131 in the longitudinal direction. The discharge port 134 is provided at the other end side of the developer tank 131 where the developing roller 132 is not provided. In the direction in which the developer flows, the developing roller 132 is at the upstream side, and the discharge port 134 is at the downstream side. In the developing tank 131, the height thereof between the developing roller 132 and the discharge port 134 in the height direction is made low as compared with the height at the other position. In the first mixer 136, the diameter of a screw at a position near the discharge port 134 is made small, and the pitch is made narrow. The flow rate of the developer in the developer tank 131 is reduced in the vicinity of the discharge port 134 by the shape of the developer tank 131 and the first mixer 136. Accordingly, when the developer flows in the arrow direction shown in FIG. 5, the surface of the developer (thick solid line of FIG. 5) flowing in the developer tank 131 rises at the side where the discharge port 134 of the developer tank 131 is provided and is mounded. The discharge port 134 is provided based on the shapes of the developer tank 131 and the first mixer 136 and the rotation speed of the first mixer 136, so that the top portion of the mound of the developer surface coincides with the center lower end of the discharge port 134 in the state where a reference amount of developer is contained in the developer tank 131. Accordingly, the developer surface is not abruptly changed at the position where the discharge port 134 is provided. Further, when a developer is newly replenished from the toner cartridge 40a to the developing device 13a through the toner hopper 41a, the developer in the developer tank 131 overflows from the discharge port 134 by the amount of the supplied developer, and is stably discharged to the outside of the developer tank 131.

Here, as shown in FIG. 6, the developer is replenished to the developing device 13a from the toner cartridge 40a through the replenishment port 133 when the toner density detection device 138 detects that the toner density of the developing device 13a is lower than a specified value. When the developing device 13a develops the electrostatic latent image formed on the photoconductive drum 11a with toner, the toner density in the developing device 13a is reduced. The toner density detection device 138 detects whether the toner density in the developing device 13a is lower than the specified value. The toner hopper 41a supplies the developer to the developing device 13a by a supplying roller 42a through the replenishment port 133 when the amount of the developer in the developing device 13a is detected to become low based on output of the toner density detection device 138.

The toner density in the developing device 13a is kept constant since a toner is replenished from the toner hopper 41a into the developing device 13a. The carrier, together with the toner, is also replenished from the toner cartridge 40a to the developing device 13a. The developer in the developer tank 131 overflows from the discharge port 134 by the amount of the supplied developer. Accordingly, the amount of the developer in the developer tank 131 is kept constant. Further, in the developer tank 131, the old degraded carrier is discharged from the discharge port 134, and is replaced by a new carrier little by little.

Next, the developer will be described. The developer of this embodiment is a two-component developer including a toner and a magnetic carrier. The toner including a binding resin and a colorant as its main ingredients is used. As the binding resin, polystyrene, styrene-acryl copolymer, polyester, epoxy resin, silicone resin, polyamide, paraffin wax or the like can be used. As the colorant, a pigment or a dye is used, and carbon black, aniline blue, pigment red, pigment yellow or the like is used. Besides, a charge control agent, a cleaning assist agent, a peeling promoting agent, a fluidity promoting agent, or the like can be contained when necessary.

As the carrier, a magnetic particle of ferrite, iron oxide or the like is used, or the magnetic particle is made a core member and is coated with resin, and the thus formed carrier can be used. As the resin coated on the carrier, fluorine resin, acrylic resin, silicone resin or the like can be used. One of or a combination of some of these resins can also be used. A resin containing magnetic powder can also be used.

Further, a developer for replenishment will be described. A two-component developer in which a toner and a carrier are mixed is prepared by a mixing device. A Henschel mixer or the like is used as the mixing device. The developer for replenishment is mainly toner, and a small amount of carrier is mixed therein.

The developer supplied as stated above includes the toner and the carrier. Here, although the toner is consumed by image formation, the carrier remains in the developer tank 131 of the developing device 13a. Thus, when the toner density of the developer in the developer tank 131 is kept constant, the developer amount in the developer tank 131 is increased by the replenishment of the developer. Thus, the excessive developer in the developer tank 131 overflows from the developer discharge port 134 for developer discharge provided in the wall surface of the developer tank 131 and is discharged to the outside of the developer tank 131. As stated above, the replenishment and discharge of the developer is successively repeated, so that the degraded developer in the developer tank 131 is replaced by the newly supplied developer. In the developer tank 131, by the replenishment and discharge of the developer as stated above, the characteristic of the developer is kept excellent, and the developer amount is kept constant. However, the discharge amount of developer discharged by the overflow is liable to be influenced by the physical property of the developer.

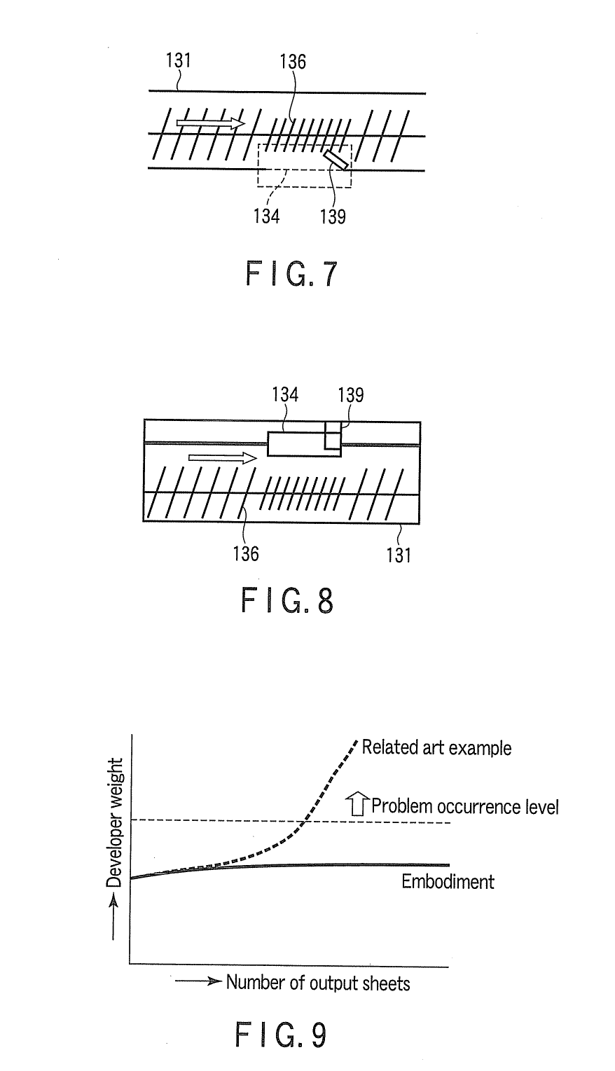

Next, the discharge assisting member 139 provided in the developing device 13a of the embodiment will be described. FIG. 7 is an enlarged top sectional view of the developing device 13a showing a broken line portion of FIG. 4. FIG. 8 is an enlarged side sectional view of the developing device 13a showing a broken line portion of FIG. 5.

The discharge assisting member 139 is a rectangular flat plate. The discharge assisting member 139 is provided to protrude in an inner direction of the developing device 13a at the downstream side of the discharge port 134 in the direction of flow of the developer and in a direction crossing the direction of the flow of the developer. The discharge assisting member 139 has an acute angle with respect to an inner wall surface of the developer tank 131 at the upstream side in the direction of the flow of the developer with respect to the position where the discharge assisting member 139 is provided. The discharge assisting member 139 is provided to contact with one side of the discharge port 134. Further, the lower side of the discharge assisting member 139 is provided above the lower side of the discharge port 134 in the height direction of the developing device 13a. Further, the upper side of the discharge assisting member 139 is provided above the upper side of the discharge port 134 in the height direction of the developing device 13a.

Here, the image forming apparatus 101 is used and image output of 300 thousand sheets in total is performed. An original document having an image print ratio of 70% is used, the weight of the developing device 13a is measured every 10 thousand sheets, and the developer weight is obtained. FIG. 9 is a graph showing a relation between the number of sheets of image output of the image forming apparatus 101 and the developer weight. A solid line indicates the embodiment in which the developing device 13a provided with the discharge assisting member 139 is used for the image forming apparatus 101. A broken line indicates a related art example in which the developing device 13a not provided with the discharge assisting member 139 is used for the image forming apparatus 101. Here, it is assumed that a case where the weight of developer contained in the developing device 13a exceeds 500 g is a problem occurrence level. When the developing device 13a contains the developer whose weight exceeds the problem occurrence level, the output image of the image forming apparatus 101 is degraded.

In the related art example, in a print ratio of 70% and a high humidity environment, the amount of discharge of the developer from the discharge port 134 is almost zero at the time point in the life of 200 thousand sheets. In the related art example, at this time point, the developer weight in the developing device 13a is increased by 100 g or more from the start of the image output of the image forming apparatus 101. In the related art example, at this time point, the developer weight significantly exceeds 500 g of the problem occurrence level. When the developer amount is increased, the height of the developer in the portion of the first mixer 136 under the developing roller 132 becomes high, and accordingly, the developer which is used in the development and in which the toner is consumed is hard to be taken in by the first mixer 136, and the developer is again sent to the developing section while being attached to the developing roller 132. So-called defective peeling occurs. Thus, the output image of the image forming apparatus 101 becomes a blurred image.

The discharge of the developer from the discharge port 134 when the developer in the developing device 13a is excessively increased is observed. In the related art example, even when the surface of the developer contained in the developing device 13a is positioned above the lower side of the discharge port 134 in the height direction of the developing device 13a, the developer does not overflow from the discharge port 134.

On the other hand, in the embodiment, in a print ratio is 70% and a high humidity environment, even at the time point in the life of 200 thousand sheets, the developer weight in the developing device 13a is 420 g and is stable. The developer appropriately overflows from the discharge port 134 by the discharge assisting member 139. In the embodiment, the developer weight in the developing device 13a does not exceed the problem occurrence level.

As described above, according to the embodiment, the developer appropriately overflows from the discharge port 134. In this embodiment, even at the time of image output of a large number of sheets, the excessive increase of the developer weight in the developing device 13a is suppressed, and the developer weight at a problem-free level can be kept. Accordingly, the output image of the image forming apparatus 101 does not become a blurred image.

Here, although the discharge assisting member 139 is integrally provided to protrude from the side wall of the developer tank 131, even when the discharge assisting member is integrally provided to protrude downward from the inner wall of the upper surface of the developer tank 131, the developer weight and the output image have a problem-free level similarly to the above.

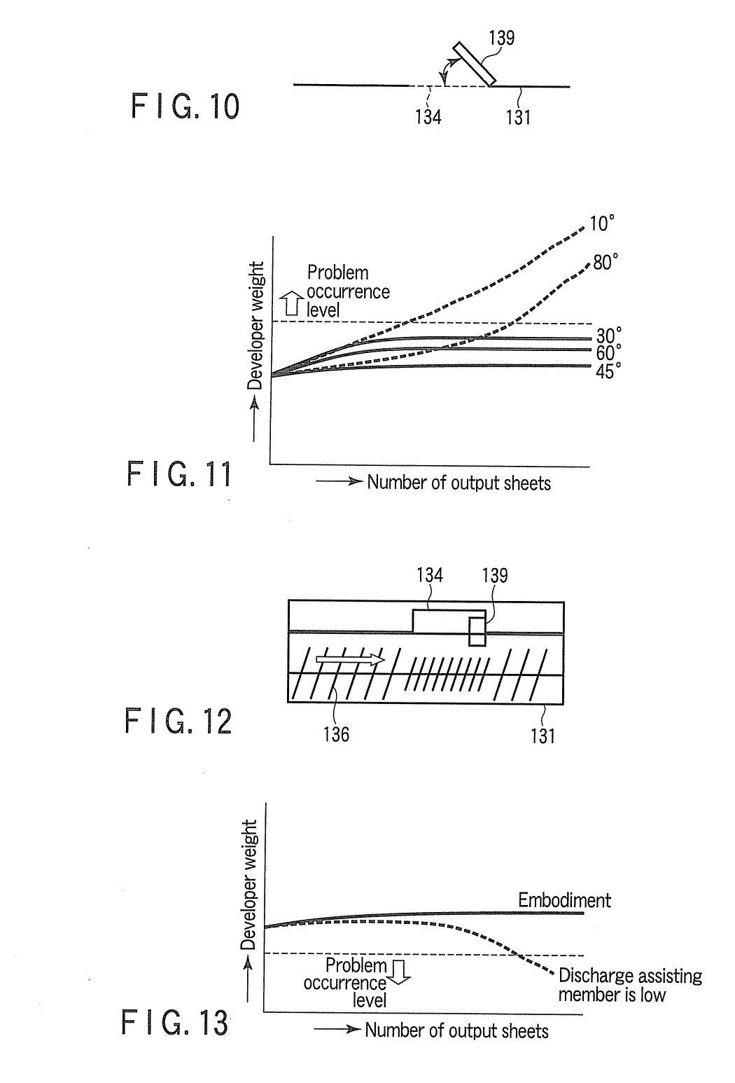

Next, an excellent arrangement of the discharge assisting member 139 provided in the developing device 13a of the embodiment will be described. FIG. 10 is an enlarged top sectional view of the developing device 13a showing a broken line portion of FIG. 7. FIG. 11 is a graph showing a relation between the number of sheets of image output of the image forming apparatus 101 and the developer weight when the arrangement of the discharge assisting member 139 is changed.

Here, as shown in FIG. 10, the discharge assisting member 139 is provided in the developing device 13a while the acute angle with respect to the inner wall surface of the developer tank 131 is changed from 10 to 80°. FIG. 11 shows results obtained when the developer weight of the developing device 13a is measured while the angle of the discharge assisting member 139 is changed.

When the angle of the discharge assisting member 139 is 30 to 60°, the developer in the developing device 13a appropriately overflows from the discharge port 134 by the discharge assisting member 139. Thus, the developer weight in the developing device 13a becomes stable. The increased amount of the developer in the developing device 13a is small and is a reference weight of 50 g or less. Accordingly, the developer weight in the developing device 13a does not exceed the problem occurrence level.

On the other hand, when the angle of the discharge assisting member 139 is smaller than 30°, the effect of the discharge assisting member 139 to discharge the developer from the discharge port 134 to the outside of the developing device 13a becomes low. For example, when the angle of the discharge assisting member 139 is 10°, as the number of sheets of image output increases, the developer weight is increased. Thus, there is a problem that the output image of the image forming apparatus 101 becomes a blurred image.

Also when the angle of the discharge assisting member 139 is larger than 60°, the effect of the discharge assisting member 139 to discharge the developer from the discharge port 134 to the outside of the developing device 13a becomes low. For example, when the angle of the discharge assisting member 139 is 80°, as the number of sheets of image output increases, the developer amount increases.

When the angle of the discharge assisting member 139 is larger than 60°, the effect of the discharge assisting member 139 to prevent the flow of the developer in the developer tank 131 becomes higher than the effect to discharge the developer from the discharge port 134 to the outside of the developing device 13a. Accordingly, the discharge assisting member 139 has a bad influence of promoting the increase of the developer weight in the developing device 13a. Thus, also in this case, there is a problem similar to the case where the angle of the discharge assisting member 139 is 10°.

From the above, it is preferable that the discharge assisting member 139 is provided in the developing device 13a while the acute angle with respect to the inner wall surface of the developer tank 131 is in a range of 30 to 60°.

Next, the position of the discharge assisting member 139 in the height direction provided in the developing device 13a of the embodiment will be described. FIG. 12 is a side sectional view showing, as a comparative example, a developing device 13a in a case where the discharge assisting member 139 is provided in the developing device 13a at a position different from FIG. 8. In FIG. 12, the discharge assisting member 139 is provided in the developing device 13a so that the lower side of the discharge assisting member 139 is lower than the lower side of the discharge port 134 in the height direction of the developing device 13a.

FIG. 13 is a graph showing a relation between the number of sheets of image output of the image forming apparatus 101 and the developer weight. A solid line indicates the embodiment in which the developing device 13a provided with the discharge assisting member 139 at the position shown in FIG. 8 is used for the image forming apparatus 101. A broken line indicates the comparative example in which the developing device 13a provided with the discharge assisting member 139 at the position shown in FIG. 12 is used for the image forming apparatus 101.

In the developing device 13a shown in FIG. 8, as shown in FIG. 13, even if the number of sheets of image output increases, the developer weight is stable. The developer weight in the developing device 13a does not become lower than a problem occurrence level. Here, the developer weight at the problem occurrence level indicates a case where a problem on an image, such as a defective image or mixer trace, occurs since the developer in the developing device 13a is excessively small.

On the other hand, in the developing device 13a shown in FIG. 12, as shown in FIG. 13, as the number of sheets of image output increases, the developer weight becomes smaller than the reference amount, and becomes lower than the problem occurrence level. The reason why the developer weight of the developing device 13a shown in FIG. 12 becomes smaller than the reference amount will be described below.

When the developing device 13a contains a reference amount of developer, the height of the developer surface is almost identical to the height of the lower side of the discharge port 134 in the height direction of the developing device 13a. When the developer is excessively supplied to the developing device 13a and the amount is the reference amount or more, the developer surface becomes higher than the lower side of the discharge port 134. When the developing device 13a contains the reference amount of developer, the developing device 13a is not required to discharge the developer from the developing device 13a to the outside. When the developing device 13a contains the reference amount of developer or more, the developing device 13a is required to discharge the developer from the developing device 13a to the outside. However, when the developing device 13a contains the reference amount of developer, as shown in FIG. 12, when the lower side of the discharge assisting member 139 is arranged to be lower than the lower side of the discharge port 134, the discharge assisting member 139 urges the developer to overflow from the discharge port 134. That is, the discharge assisting member 139 urges the discharge of the developer, and operates in a direction of reducing the developer weight of the developing device 13a from the reference amount.

From the above, it is preferable that the discharge assisting member 139 is provided in the developing device 13a such that the lower side of the discharge assisting member 139 is arranged to be higher than the lower side of the discharge port 134.

According to the discharge assisting member 139 of the embodiment, even in the case where the developer in the developing device 13a is put in the state where the developer fluidity is lowered due to the degradation in the life or environment and the developer is hard to be discharged, the developer can be efficiently discharged to the outside of the developing device 13a. Thus, in the developing device 13a, there does not arise a problem that the developer in the developing device 13a excessively increases. Further, according to the discharge assisting member 139 of the embodiment, in the state where the developing device 13a contains the reference amount of developer, the discharge assisting member does not promote the discharge of the developer more than necessary. Accordingly, in the developing device 13a, there does not occur a harmful effect that the developer is excessively reduced from the reference amount.

What is claimed is:

1. A developing device comprising:
a developer tank that contains a developer including a toner and a carrier;
a developing agent supplier that develops a latent image by using the toner contained in the developer tank;
a discharge port that is provided in a side surface of the developer tank and discharges the developer; and
a discharge assisting member that protrudes from a downstream side of the discharge port in a direction of flow of the developer in the developer tank and in a direction crossing the direction of the flow of the developer.

2. The device of claim 1, wherein
an angle between the discharge assisting member at an upstream side in the direction of the flow of the developer and the side surface of the developer tank is acute.

3. The device of claim 2, wherein
the angle is 30 to 60°.

4. The device of claim 1, wherein
a lower side of the discharge port is provided in a horizontal direction.

5. The device of claim 4, wherein
the lower side of the discharge port is provided at a position almost coincident with a surface position of the developer when a reference amount of the developer is contained in the developer tank.

6. The device of claim 4, wherein
the discharge assisting member is provided at a position higher than the lower side of the discharge port.

7. The device of claim 1, wherein
the discharge assisting member protrudes from the side surface of the developer tank.

8. The device of claim 1, wherein
the discharge assisting member protrudes from a top surface of the developer tank.

9. The device of claim 1, wherein
the discharge assisting member is a flat member.

10. The device of claim 1, comprising:
a partition plate that partitions the developer tank into a first space and a second space in a longitudinal direction of the developer tank;
a first mixer that agitates the developer in the first space of the developer tank partitioned by the partition plate and conveys the developer in the longitudinal direction of the developer tank and in a constant direction; and
a second mixer that agitates the developer in the second space of the developer tank partitioned by the partition plate and conveys the developer in the longitudinal direction of the developer tank and in an opposite direction to a conveyance direction of the developer by the first mixer.

11. The device of claim 10, wherein
the discharge port is provided at a side of the first space.

12. The device of claim 10, comprising:
a replenishment port that is provided at a side of the second space of the developer tank and replenishes the developer from a toner cartridge to the developer tank.

13. The device of claim 11, wherein
the discharge port is provided at an opposite side in the longitudinal direction of the developer tank to a side where the developing agent supplier is provided and at a downstream side in the direction of the flow of the developer.

14. The device of claim 1, comprising:
a detection unit that detects a toner density of the developer contained in the developer tank.

15. An image forming apparatus comprising:
an image carrier that holds a latent image;
a charging charger that uniformly charges the image carrier;
a developer tank that contains a developer including a toner and a carrier;
a developing agent supplier that develops the latent image formed on the image carrier by using the toner contained in the developer tank;
a discharge port that is provided in a side surface of the developer tank and discharges the developer; and
a discharge assisting member that protrudes from a downstream side of the discharge port in a direction of flow of the developer in the developer tank and in a direction crossing the direction of the flow of the developer.

16. The apparatus of claim 15, wherein
an angle between the discharge assisting member at an upstream side in the direction of the flow of the developer and the side surface of the developer tank is acute.

17. The apparatus of claim 16, wherein
the angle is 30 to 60°.

18. The apparatus of claim 15, wherein
the discharge assisting member is provided at a position higher than a lower side of the discharge port.

19. The apparatus of claim 15, comprising:
a detection unit that detects a toner density of the developer contained in the developer tank; and
a cartridge that replenishes the developer to the developing device when the detection unit detects that the toner density is lower than a specified value.

20. A developing device comprising:
means for containing a developer including a toner and a carrier;
means for developing a latent image by using the toner;
means for discharging the developer to an outside; and
means for assisting discharge of the developer, which protrudes from a downstream side of a position where the developer is discharged to the outside in a direction of flow of the contained developer and in a direction crossing the direction of the flow of the developer.
